(19) United States
(12) Patent Application Publication
(10) Pub. No.: US 2010/0272505 A1
(43) Pub. Date: Oct. 28, 2010

(54) POST COUPLING ASSEMBLY

(76) Inventor: Lefebvre Daniel, Salaberry de Valleyfield (CA)

Correspondence Address: INVENTION QUEBEC INC., Suite 202, 8065, Boul. Viau, Montreal, QC, H1R 2T2, CA

(21) Appl. No.: 12/659,547

(22) Filed: Mar. 12, 2010

(30) Foreign Application Priority Data
Apr. 28, 2009 (GB) 0907230.7

(51) Int. Cl. F16B 7/18; B23P 11/00

(52) U.S. Cl. 403/306; 29/428

(57) ABSTRACT

A coupling assembly for coupling a post first section and a post second section to each other, the coupling assembly comprising: a first support member, the first support member defining a first member post attachment for attaching the post first section thereto; a second support member, the second support member defining a second member post attachment for attaching the post second section thereto; a pivot provided between the first and second support members for pivotally coupling the first and second support members to each other so that the first and second support members are pivotable about the pivot to change an angular relationship between the first and second support members; and a lock for locking the first and second support members in a substantially fixed angular relationship relatively to each other.

The application claims priority from UK Patent Application 0907230.7 filed on Apr. 28, 2009.

### FIELD OF THE INVENTION

The present invention relates to the field of posts, and is particularly concerned a post coupling assembly for coupling two post sections to each other.

### BACKGROUND

It is well known in the art that sign posts and, more particularly, traffic sign posts holding signs such as, for examples, stop signs, street name signs, speed limit signs and the like, often end up skewed or slanted one way or the other. There are many reasons that can cause a sign post to end up skewed or slanted such as, for examples, being bumped or hit by a car or truck, as well as the cyclical effect of the seasonal freezing and thawing in temperate regions, which can significantly alter the density disposition of the ground surrounding the buried portion of the post.

To fix this problem, the posts are either replaced, manually straightened or dug out and reinserted in the ground. All these methods are relatively time-consuming and can result in relatively large expenses. There are some existing posts that include two sections that can be tilted relatively to each other. However, these posts need to include the tilting mechanism at the time of manufacturing, which can be relatively expensive if all the posts are to be fitted with this tilting mechanism. Also, the range of motions between two posts sections of such posts is typically relatively small and the methods used to tilt the two post sections are either relatively difficult to perform, or are implemented using relatively cumbersome and expensive mechanisms.

Against this background, there exist a need for an improved post coupling assembly. It is a general object of the present invention to provide a new and improved post coupling assembly.

### SUMMARY OF THE INVENTION

In a broad aspect, the invention provides a coupling assembly for coupling a post first section and a post second section to each other, the coupling assembly comprising: a first support member, the first support member defining a first member post attachment for attaching the post first section thereto; a second support member, the second support member defining a second member post attachment for attaching the post second section thereto; a pivot provided between the first and second support members for pivotally coupling the first and second support members to each other so that the first and second support members are pivotable about the pivot to change an angular relationship between the first and second support members; and a lock for locking the first and second support members in a substantially fixed angular relationship relatively to each other.

According to an embodiment of the present invention, the coupling assembly generally comprises a pair of substantially identical support members, a spherical ball element, and a plurality of nuts and bolts fasteners for assembling and mounting the coupling assembly to a suitable portion of a skewed or slanted sign post that has been beforehand transversally cut in two for inserting the coupling assembly.

Each support member is generally represented by a substantially elongated member and a plate that is transversally and centrally fastened at one end of the elongated member.

The pair of support members are swivellably assembled with their outward surface disposed in an oppositely facing configuration and separated by the spherical ball element that is constrained in corresponding recesses provided centrally in the thus oppositely facing surfaces of the plates. A plurality of corresponding through holes on the periphery of the thus oppositely facing plates allows fastening therethrough a corresponding number of nuts and bolts fasteners.

The thus oppositely extending elongated members of the coupling assembly may each be fastened to one of the adjacent proximal ends created by a transversal cut along the elongated post portion of a slanted sign post. The elongated members may be fastened to their respective proximal ends using any suitable fastening means such as, for example, conventional nuts and bolts fasteners tightened through corresponding through holes that are common to the elongated members of the coupling assembly and the proximal ends of the post. The nuts and bolts fasteners joining the oppositely facing plates of the coupling assembly may then be adjustably tightened such that a desired upstanding attitude of the upper portion of the sign post is achieved. In this embodiment, the coupling assembly is retrofittable to the existing sign post.

Some advantages of the present invention are to provide a coupling assembly for straightening sign posts and the like which can be easily installed on an existing post that has been accidentally bent or is displaying a slanted attitude due to the cyclical freezing and thawing of the grounds; whose cost of installation on an existing sign post that has been bent over is generally significantly less than the cost of replacement and installation of a brand new sign post, and is all the more significantly less costly for each subsequent occasion where the same sign post needs to be straighten up since the already installed coupling assembly only needs a re-adjustment; which can be advantageously and economically pre-installed on new traffic sign posts; which is simple and economical to manufacture; and which includes a pivot that facilitates attitude adjustments while bringing robustness to the coupling assembly.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

FIG. 1, in a front elevational view, illustrates a coupling assembly according to an embodiment of the present invention;

FIG. 2, in a top plan, cross-sectional view taken along section line II-II of FIG. 1, illustrates the coupling assembly shown in FIG. 1;

FIG. 3, in an enlarged, fragmented exploded view, illustrates the coupling assembly of FIG. 1, here shown without fastening nuts and bolts;

FIG. 4, in an enlarged, fragmented view, illustrates the coupling assembly of FIG. 1,

FIG. 5, in an environmental, front elevational view, illustrates a typically slanted sign post, shown having a transversal cut at an appropriate location along its elongated post for inserting the coupling assembly shown in FIG. 1;

FIG. 6, in an environmental, elevational view, illustrates a straightened up sign post using the coupling assembly of FIG. 1;

FIG. 7, in an environmental, elevational view, illustrates a newly installed sign post pre-equipped with the adjustable coupling assembly of FIG. 1; and

FIG. 8, in a side partial cross-sectional view, illustrates a coupling assembly in accordance with an alternative embodiment of the present invention.

### DETAILED DESCRIPTION

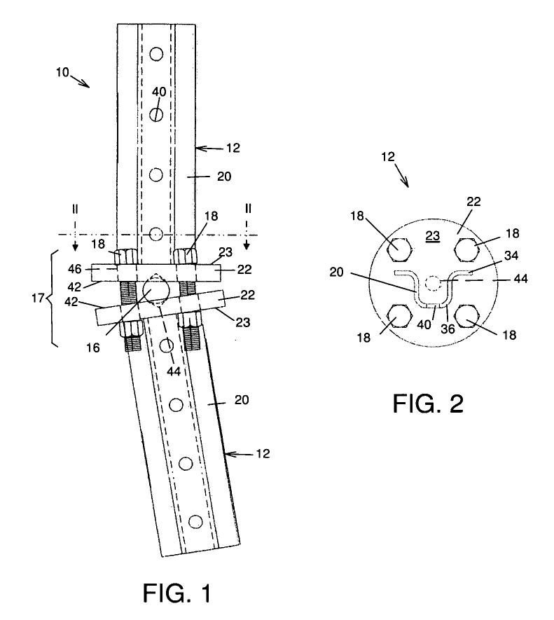

FIGS. 1 to 4 best show the various aspects of an embodiment of a coupling assembly 10 according to the present invention. As shown in FIG. 1, the coupling assembly 10 generally comprises a pair of substantially similar support members 12, a pivot taking the form of a substantially spherical ball 16, and a lock 17 including a plurality of nuts and bolts fasteners 18.

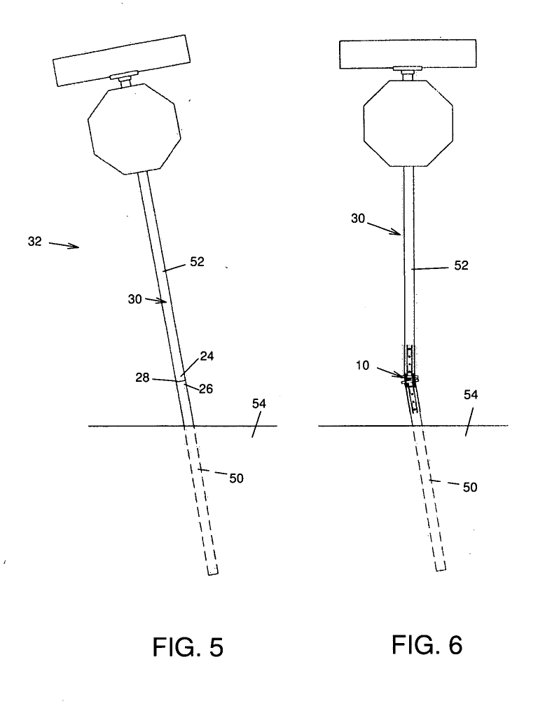

Each of the support members 12 is generally represented by a post attachment 20 and a plate 22. The post attachment 20 is typically substantially elongated and suitably shaped and sized to be longitudinally fastened to one of the two adjacent proximal ends 24, 26 created by a transversal cut 28 provided at a suitable location along the elongated post 30 of a sign post 32 (as shown in FIG. 5). The pivot is provided between the support members 12 for pivotally coupling the support members 12 to each other so that the support members 12 are pivotable about the pivot to change an angular relationship between the support members 12. Typically, the pivot allows pivotal movements of the support members 12 relatively to each other in at least two different directions. However, the pivot may allow pivotal movement in only one direction in alternative embodiments of the invention, for example if the pivot includes a cylindrical element instead of the ball 16. The lock 17 is provided for locking the support members 12 in a substantially fixed angular relationship relatively to each other.

For example, FIG. 2 shows a top plan, cross-sectional view of a post attachment 20 having a substantially U-shaped transversal cross-sectional configuration with outwardly extending flanges 34. It is to be noted that the central portion 36 of the U-shaped cross-section may be compatibly shaped to snugly fit, in a piggy-back relation, within the correspondingly U-shaped cross-section of a post 30 or, inversely, may be compatibly shaped to snugly fit outside the U-shaped cross-section of a post 30.

Furthermore, it is to be noted that the post attachment 20 may have any other suitably shaped cross-section adapted to firmly fasten the latter to posts 30 having a differently shaped cross-section. For examples, the post attachment 20 may have a U-shaped cross-section provided with a relatively narrow central portion 36 adapted to be fasted in a piggy-back relation to a post 30 having a substantially T-shaped cross-section, or the post attachment 20 may have a tubularly hollow cross-section such as a square, rectangular, hexagonal, octagonal, or the like, configuration in order to be firmly fastened, in a coaxial relation, within or around a compatibly shaped tubular post 30. As seen in FIG. 1, the post attachment 20 is further provided with a plurality of longitudinally distributed attachment apertures 40 extending therethrough and adapted to allow to longitudinally fasten the post attachment 20 in a piggy-back relation along one of the adjacent proximal ends 24, 26 of a post 30. In some embodiments of the invention, the post attachments 20 are removably attachable to the post 30.

A distal end of the post attachment 20 is provided with a plate 22 that is generally represented by a substantially planar element that may have any suitable shape, such as a rounded shape as shown in FIG. 2. The plate 22 is substantially adjacent the pivot formed by the ball 16. The plate 22 has a first surface 23 that is transversally and centrally fastened to a distal end of the post attachment 20 using any suitable connecting process such as, for example, a welding process. The support member 12 may also be formed as a one piece element using any suitable injection-molding process.

The opposite, outwardly facing, surface 42 is provided with a centrally disposed and substantially conically-shaped recess 44 for engaging a surface portion of the ball 16. However, the recess 44 may have any other suitable shape, as long as the recess 44 partially receives the ball 16. Furthermore, at least two, but typically four plate coupling apertures 46 are disposed proximal the peripheral edge of plate 22 for receiving a respective one of the fasteners 18.

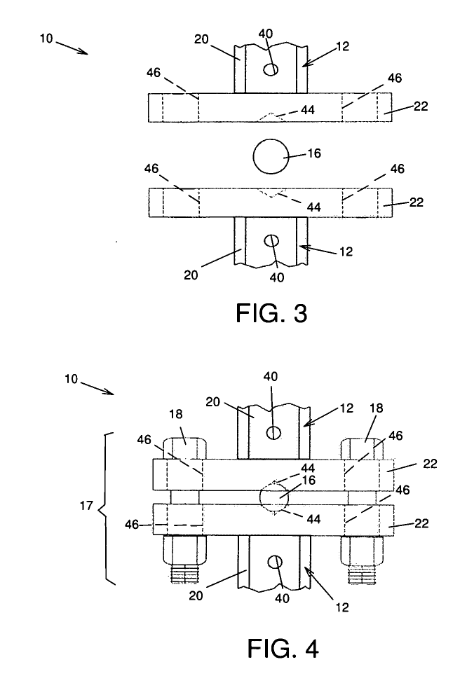

The ball 16 may have any suitable diameter such that, when it is positioned between the oppositely corresponding conically-shaped recesses 44 of a pair of oppositely facing support members 12, as shown in FIGS. 3 and 4, each support member 12 may thus swivel about the spherical surface of the ball 16 such that their respective post attachments 20 may be longitudinally aligned, or form an angle between zero and roughly 45 degree relative to one another, for example.

The support members 12, the ball 16 and the plurality of nuts and bolts fasteners 18 are preferably made of a suitably rigid and rust proof material such as, for examples, a suitably treated steel, aluminum, or the like.

When assembled, the two support members 12 are positioned such that the recesses 44 face each other with the plate coupling apertures 46 being pairwise substantially in register with each other and the post attachments 20 extending away from each other. The lock 17 includes the fasteners 18 that each extends through respective substantially in register plate coupling apertures 46 provided in the plates 22 of the two support members 12 for fastening the plates 22 to each other in a substantially fixed relationship relatively to each other.

A mode of usage of the coupling assembly 10 generally consist of, first, transversally sectioning a skewed or slanted sign post 32 at a suitable location along the elongated post 30, such as illustrated in FIG. 5, thus creating a pair of adjacent proximal ends 24 and 26 respectively. The post attachment 20 of a first support member 12, having its plate 22 oriented upwardly, may be rigidly fastened to proximal end 26 of the post lower portion 50 partially buried in the ground 54 using any suitable means such as, for examples, a plurality of bolts and nuts fasteners, or rivets (not shown) fastened through corresponding attachment apertures 40 of the post attachment 20 and conventional holes (not shown) provided through post lower portion 50.

In a similar manner, a second support member 12, with its plate 22 equipped end portion oriented downwardly, has its post attachment 20 rigidly fastened to the lower proximal end 24 of the post upper portion 52 of the post 30. It is to be noted that the post attachments 20 of the support members 12 may as well be fastened to their respective proximal ends 24, 26 using any other suitable connecting means such as, for example, a welding process.

The ball 16 may then be positioned in the upwardly facing conically-shaped recess 44 of the support member 12 fastened to the post lower portion 50, followed with centrally positioning the oppositely facing recess 44 under the upstanding support member 12 fastened to the post upper portion 52, on top of the ball 16. The nuts and bolts fasteners 18 may then be slidably engaged and loosely fastened through the corresponding plate coupling apertures 46 of the thus oppositely facing plates 22. The tightening of the nuts and bolts fasteners 18 may then be adjustably tightened such that a predetermined relative attitude between the post upper and lower portions 50 and 52 of the post 30 is achieved, as illustrated in FIG. 6. This is performed by pivoting the support members 12 relatively to each other to achieve the predetermined relative attitude between the post lower and upper portions 50 and 52 and then locking the lock 17 to lock this predetermined attitude. For example, the predetermined attitude is such that the post upper portion 52 is substantially vertical.

Alternatively, the elements of the coupling assembly 10 may be assembled beforehand, as described above, then have its post attachments 20 fastened to their respective proximal ends 24, 26 of the post lower and upper portions 50 and 52 and, finally, have the nuts and bolts fasteners 18 adjustably tightened such that a desired attitude of the upper portion 52 of the post 30 is achieved.

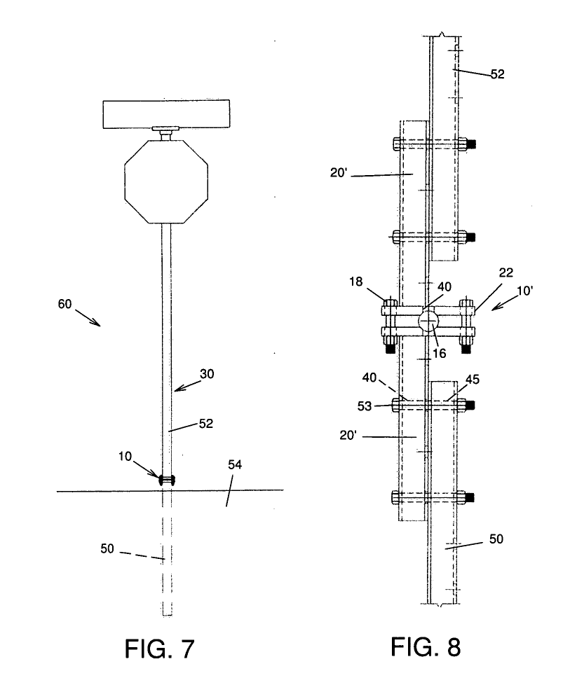

FIG. 7 shows an coupling assembly 10 pre-installed on a new sign post 60 for providing an integrated means readily available for future straightening operations.

FIG. 8 illustrates an alternative coupling assembly 10′ similar to the above-described coupling assembly. Differences that exist between the coupling assembly 10′ and the coupling assembly 10 are that recesses receiving the ball 16′ take the form of apertures 44′ having a substantially cylindrical configuration and extending through the plate 22, and that the post attachments 20′ are not centrally located on the plates 22. Fasteners 53 extending through the attachment apertures 45 of the post sections 50 and 52 and attachment apertures 40 of the post attachments 20′ are shown in this Figure.

Although the present invention has been described hereinabove by way of preferred embodiments thereof, it can be modified, without departing from the spirit and nature of the subject invention as defined in the appended claims.

What is claimed is:

1. A coupling assembly for coupling a post first section and a post second section to each other, said coupling assembly comprising:
a first support member, said first support member defining a first member post attachment for attaching said post first section thereto;
a second support member, said second support member defining a second member post attachment for attaching said post second section thereto;
a pivot provided between said first and second support members for pivotally coupling said first and second support members to each other so that said first and second support members are pivotable about said pivot to change an angular relationship between said first and second support members; and
a lock for locking said first and second support members in a substantially fixed angular relationship relatively to each other.

2. A coupling assembly as defined in claim 1, wherein said first and second member post attachments are each substantially elongated.

3. A coupling assembly as defined in claim 2, wherein said first and second member post attachments each have a substantially U-shaped transversal cross-sectional configuration.

4. A coupling assembly as defined in claim 2, further comprising at least two fasteners for fastening respectively said post first and second sections to said first and second member post attachments.

5. A coupling assembly as defined in claim 4, wherein said first and second member post attachments each define at least one attachment aperture extending therethrough for receiving a respective one of said at least two fasteners.

6. A coupling assembly as defined in claim 1, wherein said pivot includes a substantially spherical ball and said first and second support members each define a respective recess partially receiving said ball.

7. A coupling assembly as defined in claim 6, wherein said recesses are substantially conical.

8. A coupling assembly as defined in claim 6, wherein said recesses are substantially cylindrical.

9. A coupling assembly as defined in claim 1, wherein said first and second support members each define a respective plate provided substantially adjacent said pivot, said lock including at least two fasteners for fastening said plates to each other in a substantially fixed relationship relatively to each other.

10. A coupling assembly as defined in claim 1, wherein said pivot allows pivotal movements of said first and second support members relatively to each other in at least two different directions.

11. A coupling assembly as defined in claim 1, wherein said first and second member post attachments are removably attachable respectively to said post first and second sections.

12. A coupling assembly as defined in claim 1, wherein said first and second support members are substantially similar to each other.

13. A coupling assembly as defined in claim 1, wherein
said first support member includes a first member plate provided with first plate coupling apertures extending therethrough, said first member post attachment extending from said first member plate, said first member plate defining a first plate recess extending thereinto;
said second support member includes a second member plate provided with second plate coupling apertures extending therethrough, said second member post attachment extending from said second member plate, said second member plate defining a second plate recess extending thereinto;
said first and second plate recesses face each other with said first and second plate coupling apertures being pairwise substantially in register with each other and said first and second member post attachments extending away from each other;
said pivot includes a substantially spherical ball provided between said first and second member plates and partially received in said first and second plate recesses;
said lock includes fasteners each extending through respective substantially in register first and second plate coupling apertures.

14. A coupling assembly as defined in claim 1, wherein said coupling assembly is retrofittable to an existing post including said post first and second sections.

15. A method for correcting the attitude of a post using a coupling assembly as defined in claim 1, said method comprising:
sectioning said post to create a post first section and a post second section;
attaching said coupling assembly to said post first and second sections with said pivot provided between said post first and second sections;
pivoting said first and second support members relatively to each other to achieve a predetermined relative attitude between said post first and second sections;
locking said lock to lock said post first and second sections in said predetermined relative attitude.

16. A method as defined in claim 15, wherein said post first section is partially buried in the ground and said post second section supports a sign, said predetermined relative attitude being such that said post second section is substantially vertical.
